(19) United States
(12) Patent Application Publication
(10) Pub. No.: US 2012/0260130 A1
(43) Pub. Date: Oct. 11, 2012

(54) NON-VOLATILE RANDOM ACCESS MEMORY TEST SYSTEM AND METHOD

(75) Inventor: MING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/430,793

(22) Filed: Mar. 27, 2012

(30) Foreign Application Priority Data
Apr. 7, 2011 (CN) 201110086332.2

(51) Int. Cl. G06F 11/28

(52) U.S. Cl. 714/32; 714/E11.178

(57) ABSTRACT

A computer and method test a non-volatile random access memory (NVRAM) of a basic input and output system (BIOS) chip of a motherboard under a diagnostic mode and a stress mode. The computer sets parameters of the diagnostic mode and parameters of the stress mode in a basic input and output system (BIOS) chip of the motherboard. The computer initializes the diagnostic mode according to the parameters of the diagnostic mode and the stress mode according to the parameters of the stress mode. The computer tests the NVRAM of the BIOS chip under the diagnostic mode and the stress mode.

### BACKGROUND

1. Technical Field

Embodiments of the present disclosure relate to information processing technology, and particularly to a non-volatile random access memory (NVRAM) test system and method.

2. Description of Related Art

A BIOS chip may include configuration information of the computer. For example, the RAID controller embeds configuration information (e.g., RAID 0 configuration) in the BIOS chip to manage one or more physical disk drives. The configuration information of the computer is stored in a non-volatile random access memory (NVRAM). It is important to test performance of the NVRAM. However, at present, testing of the NVRAM is done manually, for example, a user manually sets parameters in a menu of the BIOS interface. After the test is finished, the user manually resets the BIOS to obtain test information (e.g., a beginning time of the test, a predetermined time to finish the test, error types of the test). This is tedious and time consuming and thus, there is room for improvement in the art.

### BRIEF DESCRIPTION OF THE DRAWINGS

FIG. 1 is a system view of one embodiment of a non-volatile random access memory (NVRAM) test system.

FIG. 2 is a block diagram of one embodiment of a computer included in FIG. 1.

FIG. 3 is a flowchart of one embodiment of an NVRAM test method.

FIG. 4 is a detailed description of step S30 in FIG. 3 of one embodiment for testing the NVRAM under a diagnose mode.

FIG. 5 is a detailed description of step S40 in FIG. 3 of one embodiment for testing the NVRAM under a stress mode.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

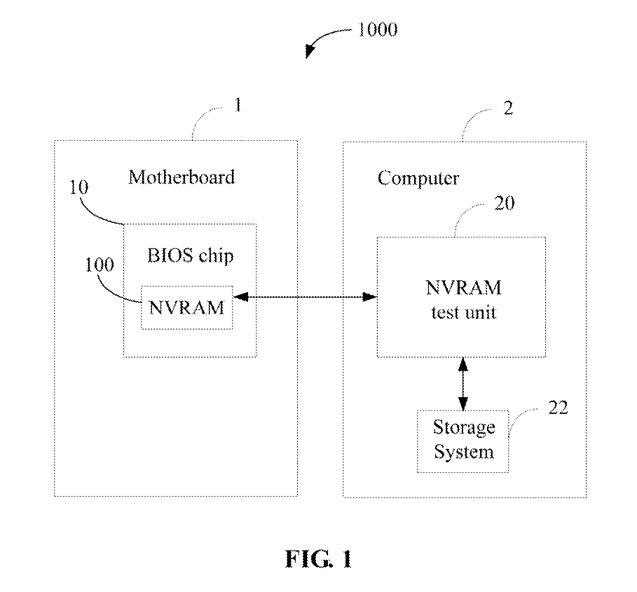

FIG. 1 is a system view of one embodiment of a non-volatile random access memory (NVRAM) test system 1000. In one embodiment, the NVRAM test system 1000 may include a motherboard 1 and a computer 2. The motherboard 1 includes a basic input output system (BIOS) chip 10 and is connected to the computer 2 via an interface, such as a universal serial bus (USB) port. The BIOS chip 10 includes an NVRAM 100. The NVRAM test system 1000 may be used to test stability of the NVRAM 100 by testing the NVRAM 100 predetermined times (e.g., 400 times). The BIOS chip 10 may be a unified extensible firmware interface (UEFI) BIOS chip.

Depending on the embodiment, the computer 2 includes an NVRAM test unit 20. Additionally, the computer 2 may be a personal computer (PC), a network server, or any item of other data-processing equipment. Further details of the NVRAM test unit 20 will be described below.

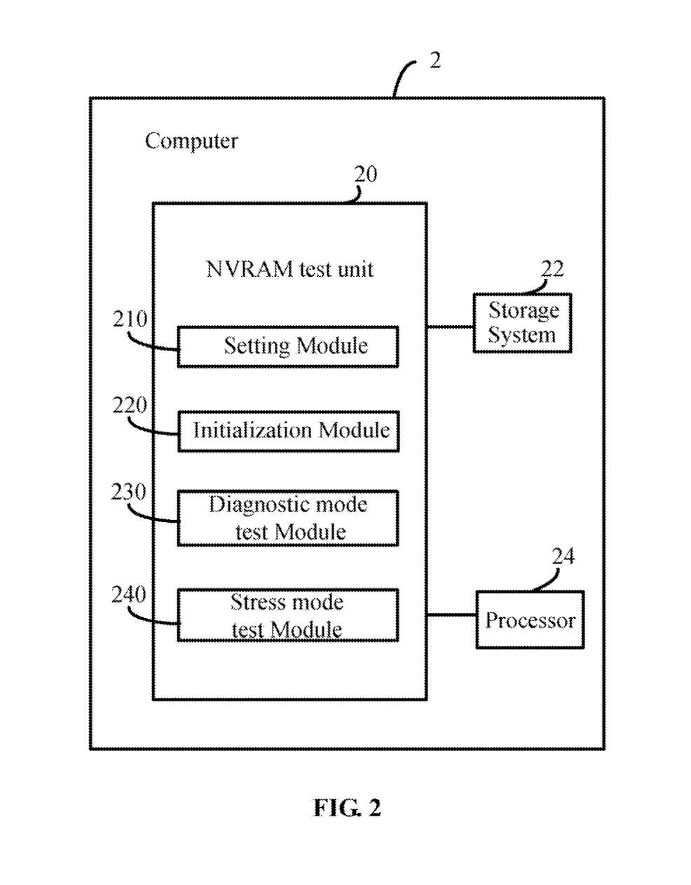

FIG. 2 is a block diagram of one embodiment of the computer 2 included in FIG. 1. In one embodiment, the computer 2 includes a storage system 22, and at least one processor 24. In one embodiment, the NVRAM test unit 20 further includes a setting module 210, an initialization module 220, a diagnostic mode test module 230, and a stress mode test module 240. The modules 210-240 may include computerized code in the form of one or more programs that are stored in the storage system 22. The computerized code includes instructions that are executed by the at least one processor 24 to provide functions for modules 210-240. The storage system 22 may be an EPROM memory chip, a flash memory stick, or a hard drive. In one embodiment, the storage system 22 further stores a test file. The test file may include a character string, for example, the character string may be “hello, I am Lee”. The NVRAM test unit 20 writes the character string into the NVRAM 100 to test the stability of the NVRAM 100.

The setting module 210 sets parameters of a diagnostic mode and parameters of a stress mode in the BIOS chip 10. In one embodiment, the parameters of the diagnostic mode includes a version of the BIOS chip 10, keywords to determine if an error occurs during the test, an interval (e.g., every two minutes) between two consecutive tests under the diagnose mode. A beginning time of the test, a predetermined time to finish testing the NVRAM 100 under the diagnostic mode and a path directory for storing a first log file generated by the BIOS chip 10 during testing the NVRAM 100 under the diagnose mode. The parameters of the stress mode include a version of the BIOS chip 10, keywords to determine if the error occurs during the test under the stress mode, an interval (e.g., every two minutes), between two consecutive tests, a predetermined number (e.g., eight thousand times), of testing the NVRAM 100 under the stress mode and a path directory for storing a second log file generated by the BIOS chip 10 during testing the NVRAM 100 under the stress mode.

The initialization module 220 initializes the diagnostic mode according to the parameters of the diagnose mode, and initializes the stress mode according to the parameters of the stress mode.

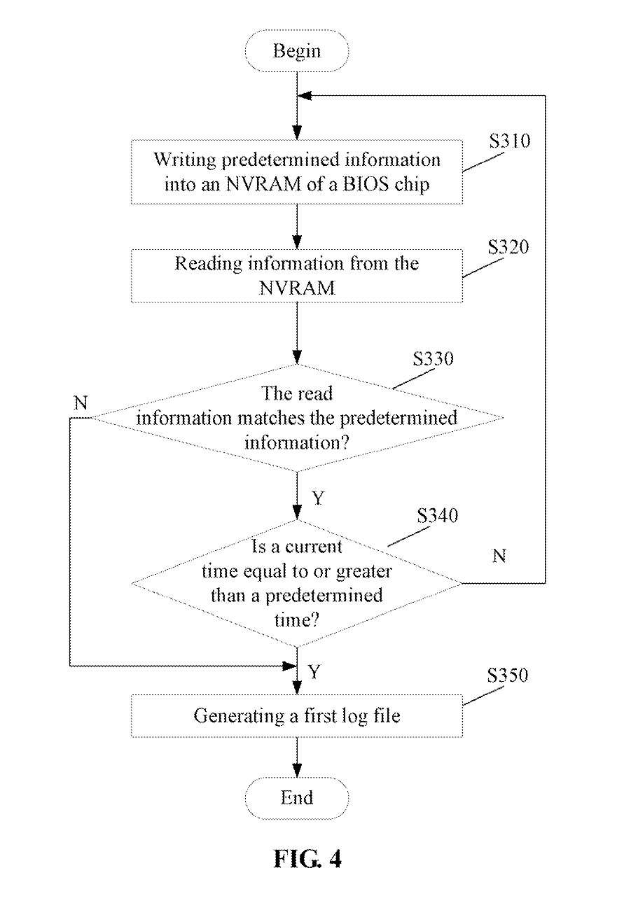

The diagnostic mode test module 230 tests the NVRAM 100 under the diagnose mode. Further details of testing the NVRAM 100 will be described below in FIG. 4.

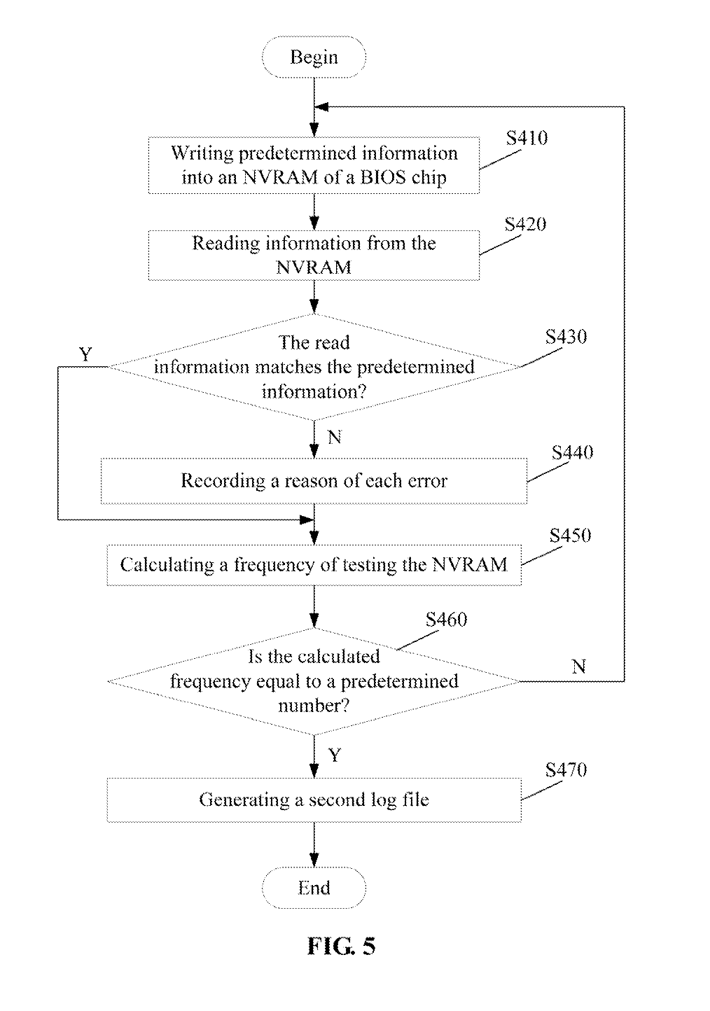

The stress mode test module 240 tests the NVRAM 100 under the stress mode. Further details of testing the NVRAM 100 will be described below in FIG. 5.

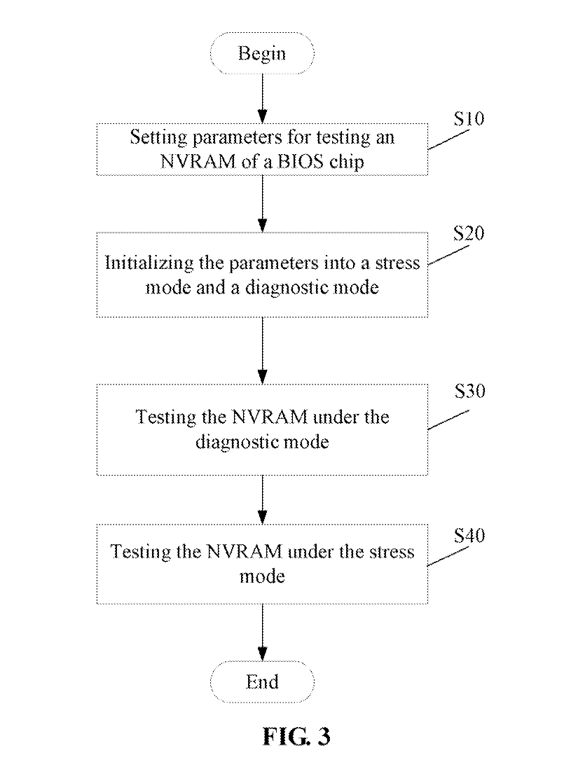

FIG. 3 is a flowchart of one embodiment of an NVRAM test method. Depending on the embodiment, additional steps may be added, others deleted, and the ordering of the steps may be changed.

In step S10, the setting module 210 sets parameters of a diagnostic mode and parameters of a stress mode in the BIOS chip 10. In one embodiment, once an error occurs when the NVRAM 100 is being tested under the diagnostic mode, the test stops. In contrast, if the NVRAM 100 is being tested under the stress mode, the test does not stop until a frequency of the test is equal to the predetermined number (e.g., eight thousand times). In other words, even if one or more errors occur as the NVRAM 100 is being tested under the stress mode, the test does not stop until the NVRAM 100 has been tested eight thousand times.

In step S20, the initialization module 220 initializes the diagnostic mode according to the parameters of the diagnostic mode, and initializes the stress mode according to the parameters of the stress mode.

In step S30, the diagnostic mode test module 230 tests the NVRAM 100 under the diagnostic mode. Further details of testing the NVRAM 100 will be described below in FIG. 4.

In step S40, the stress mode test module 240 tests the NVRAM 100 under the stress mode. Further details of testing the NVRAM 100 will be described below in FIG. 5.

FIG. 4 is a detailed description of step S30 in FIG. 3 of one embodiment for testing the NVRAM 100 under a diagnostic mode.

In step S310, the diagnostic mode test module 230 writes predetermined information into the NVRAM 100 of the BIOS chip 10. In one embodiment, the predetermined information comes from the test file stored in the storage system 22. Additionally, when the predetermined information is written into the NVRAM 100, if no error occurs in the NVRAM 100, the original data in the NVRAM 100 is replaced by the predetermined information. For example, assuming that the NVRAM 100 originally includes a character string (e.g., “hello, I am Ali”), when the predetermined information (e.g., hello, I am Lee) is written into the NVRAM 100, and the character string “hello, I am Ali” is replaced by the character string “hello, I am Lee.” In contrast, if an error occurs in the NVRAM 100 when the predetermined information is written into the NVRAM 100, the original data in the NVRAM 100 may not be replaced by the predetermined information. For example, when the predetermined information (e.g., hello, I am Lee) is written into the NVRAM 100, the NVRAM 100 may not just include the character string “hello, I am Lee”, and the character string “hello, I am Ali” may be still be included in the NVRAM 100.

In step S320, the diagnostic mode test module 230 reads information from the NVRAM 100. In one embodiment, the diagnostic mode test module 230 reads all of the information stored in the NVRAM 100.

In step S330, the diagnostic mode test module 230 determines if the read information matches the predetermined information. In one embodiment, for saving calculation resource and time, the diagnostic mode test module 230 may use the keywords to match the read information with the predetermined information. For example, the keywords may be characters “Lee” and “am”, the diagnostic mode test module 230 may use the keyword “Lee” and “am” to search the read information. Assuming that the predetermined information includes a character string “hello, I am Lee,” if the read information includes only one “Lee” and one “am,” the read information matches the predetermined information, the procedure goes to step S340. Otherwise, if the read information includes one “Lee” and two “am,” the read information does not match the predetermined information, the procedure goes to step S350.

In step S340, the diagnostic mode test module 230 determines if the current time is equal to or greater than the predetermined time. For example, assuming that the predetermined time is at 22:00 PM, if the current time is at 22:00 PM or 22:05 PM, and the current time is equal to or greater than the predetermined time, the procedure goes to step S350. Otherwise, if the current time is less than 22:00 PM, and then procedure returns to step S310.

In step S350, the diagnostic mode test module 230 generates a first log file for recording the test. The first log file may include times of writing the predetermined information (e.g., writing the string of character “hello, I am Lee” into the NVRAM 100 eight thousand times), a starting time of each time to write the predetermined information into the NVRAM 100, and a stop time when the test under the diagnostic mode ends. Additionally, the diagnostic mode test module 230 stores the first log file into the storage system 22 according to the path directory. For example, if the path directory is A/B/C, the diagnostic mode test module 230 stores the first log file into the storage system 22 under the path directory A/B/C.

FIG. 5 is a detailed description of step S40 in FIG. 3 of one embodiment for testing the NVRAM under a stress mode.

In step S410, the stress mode test module 240 writes predetermined information into the NVRAM 100 of the BIOS chip 10.

In step S420, the stress mode test module 240 reads information from the NVRAM 100. In one embodiment, the diagnostic mode test module 230 reads all of the information stored in the NVRAM 100.

In step S430, the stress mode test module 240 determines if the read information matches the predetermined information. In one embodiment, for saving calculation resource and time, the stress mode test module 240 may use the keywords to match the read information with the predetermined information. The read information matches the predetermined information upon the condition that the number of the keywords in the read information is equal to the number of the predetermined information. For example, the keywords may be characters “Lee” and “am,” the stress mode test module 240 may use the keyword “Lee” and “am” to search the read information. Assuming that the predetermined information include a character string “hello, I am Lee,” if the read information includes only one “Lee” and one “am,” the read information matches the predetermined information, the procedure goes to step S440. Otherwise, if the read information includes one “Lee” and two “am,” the read information does not match the predetermined information, the procedure goes to step S450.

In step S440, the stress mode test module 240 records a reason of each error. If the read information does not match the predetermined information, an error occurs during the test under the stress mode.

In step S450, the stress mode test module 240 calculates a frequency of testing the NVRAM under the stress mode. The stress mode test module 240 may increase the frequency of testing the NVRAM under the stress mode by one after every time stress mode test module 240 matches the read information with the predetermined information.

In step S460, the stress mode test module 240 determines if the calculated frequency is equal to a predetermined number. For example, if the calculated frequency is eight thousand and the predetermined number is eight thousand, then the calculated frequency is equal to the predetermined number, the procedure goes to step S470. Otherwise, if the calculated frequency is seven thousand and five hundred and the predetermined number is eight thousand. Then the calculated frequency is unequal to the predetermined number, the procedure returns to step S410.

In step S470, the stress mode test module 240 generates a second log file. The second log file may include times of writing the predetermined information (e.g., writing the string of character “hello, I am Lee” into the NVRAM 100 eight thousand times), a starting time of each time to write the predetermined information into the NVRAM 100, a reason for each error, and a stop time when the test under the diagnostic mode ends. Additionally, the stress mode test module 230 stores the second log file into the storage system 22 according to the path directory. For example, if the path directory is D/B/C, the stress mode test module 230 stores the second log file into the storage system 22 under the path directory D/B/C.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, the computer in electronic communication with a motherboard, the computer comprising:
a storage system;
at least one processor; and
one or more programs stored in the storage system and being executable by the at least one processor, the one or more programs comprising:
a setting module operable to set parameters of a diagnostic mode and parameters of a stress mode in a basic input and output system (BIOS) chip of the motherboard, wherein the parameters of the diagnostic mode comprises a predetermined time to finish a test under the diagnostic mode and keywords to determine if an error occurs during the test under the diagnose mode, the parameters of the stress mode comprises a predetermined number of a test under the stress mode and keywords to determine if the error occurs during the test under the stress mode;
an initialization module operable to initialize the diagnostic mode according to the parameters of the diagnose mode, and initialize the stress mode according to the parameters of the stress mode;
a diagnostic mode test module operable to test a non-volatile random access memory (NVRAM) of the BIOS chip under the diagnose mode; and
a stress mode test module operable to test the NVRAM of the BIOS chip under the stress mode.

2. The computer of claim 1, wherein the diagnostic mode test module further comprises operations to:
write predetermined information into the NVRAM of the BIOS chip;
read information from the NVRAM;
determine if the read information matches the predetermined information;
determine if current time is equal to or greater than the predetermined time in response to a determination that the read information matches the predetermined information; and
generate a first log file for recording the test in response to the current time is equal to or greater than the predetermined time.

3. The computer of claim 2, wherein the diagnostic mode test module uses the keywords to determine that the read information matches the predetermined information upon the condition that a number of the keywords in the read information is equal to the number of the predetermined information.

4. The computer of claim 2, wherein the first log file comprises times of writing the predetermined information into the NVRAM, a starting time of each time to write the predetermined information into the NVRAM, and a stop time when the test under the diagnostic mode ends.

5. The computer of claim 1, wherein the stress mode test module further comprise operations to:
write predetermined information into the NVRAM of the BIOS chip;
read information from the NVRAM;
determine if the read information matches the predetermined information;
record a reason of each error in response to a determination that the read information does not match the predetermined information;
calculate a frequency of testing the NVRAM under the stress mode;
determine if the calculated frequency is equal to a predetermined number; and
generate a second log file for recording the test in response to the calculated frequency is equal to a predetermined number.

6. The computer of claim 5, wherein the stress mode test module uses the keywords to determine that the read information matches the predetermined information upon the condition that the number of the keywords in the read information is equal to the number of the predetermined information.

7. The computer of claim 5, wherein the second log file comprises times of writing the predetermined information into the NVRAM, a starting time of each time to write the predetermined information into the NVRAM, the reason of each error, and a stop time when the test under the diagnostic mode ends.

8. An NVRAM test method implemented by a computer, the computer in electronic communication with a motherboard, the method comprising:
setting parameters of a diagnostic mode and parameters of a stress mode in a basic input and output system (BIOS) chip of the motherboard, wherein the parameters of the diagnostic mode comprises a predetermined time to finish a test under the diagnostic mode and keywords to determine if an error occurs during the test under the diagnose mode, the parameters of the stress mode comprises a predetermined number of a test under the stress mode and keywords to determine if the error occurs during the test under the stress mode;
initializing the diagnostic mode according to the parameters of the diagnose mode, and initializing the stress mode according to the parameters of the stress mode;
testing a non-volatile random access memory (NVRAM) of the BIOS chip under the diagnose mode; and
testing the NVRAM of the BIOS chip under the stress mode.

9. The method of claim 8, wherein testing the NVRAM of the BIOS chip under the diagnostic mode further comprises:
writing predetermined information into the NVRAM of the BIOS chip;
reading information from the NVRAM;
determining if the read information matches the predetermined information;
determining if the current time is equal to or greater than the predetermined time in response to a determination that the read information matches the predetermined information; and
generating a first log file for recording the test in response to the current time is equal to or greater than the predetermined time.

10. The method of claim 9, wherein the diagnostic mode test module uses the keywords to determine that the read information matches the predetermined information upon the condition that a number of the keywords in the read information is equal to the number of the predetermined information.

11. The method of claim 9, wherein the first log file comprises times of writing the predetermined information into the NVRAM, a starting time of each time to write the predetermined information into the NVRAM, and a stop time when the test under the diagnostic mode ends.

12. The method of claim 8, wherein testing the NVRAM of the BIOS chip under the stress mode further comprises:
writing predetermined information into the NVRAM of the BIOS chip;
reading information from the NVRAM;
determining if the read information matches the predetermined information;
recording a reason of each error in response to a determination that the read information does not match the predetermined information;
calculating a frequency of testing the NVRAM under the stress mode;
determining if the calculated frequency is equal to a predetermined number; and
generating a second log file for recording the test in response to the calculated frequency is equal to a predetermined number, wherein the second log file comprises times of writing the predetermined information into the NVRAM, a starting time of each time to write the predetermined information into the NVRAM, the reason of each error, and a stop time when the test under the diagnostic mode ends.

13. The method of claim 12, wherein the stress mode test module uses the keywords to determine that the read information matches the predetermined information upon the condition that a number of the keywords in the read information is equal to the number of the predetermined information.

14. A non-transitory computer-readable medium having stored thereon instructions that, when executed by a computer, the computer in electronic communication with a motherboard, causing the computer to perform an NVRAM test method, the method comprising:
setting parameters of a diagnostic mode and parameters of a stress mode in a basic input and output system (BIOS) chip of the motherboard, wherein the parameters of the diagnostic mode comprises a predetermined time to finish the test under the diagnostic mode and keywords to determine if an error occurs during a test under the diagnose mode, the parameters of the stress mode comprises a predetermined number of the test under the stress mode and keywords to determine if the error occurs during the test under the stress mode;
initializing the diagnostic mode according to the parameters of the diagnose mode, and initializing the stress mode according to the parameters of the stress mode;
testing a non-volatile random access memory (NVRAM) of the BIOS chip under the diagnose mode; and
testing the NVRAM of the BIOS chip under the stress mode.

15. The medium of claim 14, wherein the method of testing the NVRAM of the BIOS chip under the diagnostic mode further comprises:
writing predetermined information into the NVRAM of the BIOS chip;
reading information from the NVRAM;
determining if the read information matches the predetermined information;
determining if current time is equal to the predetermined time in response to a determination that the read information matches the predetermined information; and
generating a first log file for recording the test in response to the current time is equal to the predetermined time, wherein the first log file comprises times of writing the predetermined information into the NVRAM, a starting time of each time to write the predetermined information into the NVRAM, and a stop time when the test under the diagnostic mode ends.

16. The method of claim 15, wherein the diagnostic mode test module uses the keywords to determine that the read information matches the predetermined information upon the condition that a number of the keywords in the read information is equal to the number of the predetermined information.

17. The method of claim 14, wherein the method of testing the NVRAM of the BIOS chip under the stress mode further comprises:
writing predetermined information into the NVRAM of the BIOS chip;
reading information from the NVRAM;
determining if the read information matches the predetermined information;
recording a reason of each error in response to a determination that the read information does not match the predetermined information;
calculating a frequency of testing the NVRAM under the stress mode;
determining if the calculated frequency is equal to a predetermined number; and
generating a second log file for recording the test in response to the calculated frequency is equal to a predetermined number, wherein the second log file comprises times of writing the predetermined information into the NVRAM, a starting time of each time to write the predetermined information into the NVRAM, the reason of each error, and a stop time when the test under the diagnostic mode ends.

18. The method of claim 17, wherein the stress mode test module uses the keywords to determine that the read information matches the predetermined information upon the condition that the number of the keywords in the read information is equal to the number of the predetermined information.
